(19) United States
(12) Patent Application Publication
(10) Pub. No.: US 2008/0029917 A1
(43) Pub. Date: Feb. 7, 2008

(54) Process for making modified cellulosic filler from recycled plastic waste and forming wood substitute articles

(76) Inventors: Debesh Maldas, Okemos, MI (US); Timothy L. Morrison, North Palm Beach, FL (US)

Correspondence Address: AKERMAN SENTERFITT, P.O. BOX 3188, WEST PALM BEACH, FL, 33402-3188, US

(21) Appl. No.: 11/891,641

(22) Filed: Aug. 10, 2007

Related U.S. Application Data
(63) Continuation of application No. 11/475,396, filed on Jun. 27, 2006, now abandoned.
Application No. 11/475,396 is a continuation of application No. 11/004,572, filed on Dec. 3, 2004, now abandoned.
Application No. 11/004,572 is a continuation of application No. 10/123,837, filed on Apr. 16, 2002, now abandoned.
Application No. 10/123,837 is a continuation of application No. 09/761,284, filed on Jan. 16, 2001, now abandoned.

(51) Int. Cl. B29C 45/76

(52) U.S. Cl. 264/40.1; 264/349

(57) ABSTRACT

A low cost process of making modified cellulosic materials by melt blending with at least 30% recycled and comingled plastic waste stream at higher temperature and pressure where at least 70% of plastics melts and encapsulate the filler. The plastic encapsulated filler can be used as a feed stock for continuous or discontinuous process of compression, extrusion, coextrusion and injection molded structural (e.g. profiles, stake, panel) and non-structural (e.g. sheet, thin-board) articles by mixing with a thermoplastic (e.g. polyethylene, polypropylene, polyvinyl chloride, polystyrene) or a hybrid mixture of said thermoplastics, bonding agents, plastic processing additives, impact modifiers, colorant and with/without a lightner.

### CROSS REFERENCE TO RELATED APPLICATIONS

This application is a continuation of U.S. patent application Ser. No. 11/475,396, filed Jun. 27, 2006, which is a continuation of U.S. patent application Ser. No. 11/004,572, filed Dec. 3, 2004, now abandoned, which is a continuation of U.S. patent application Ser. No. 10/123,837, filed Apr. 16, 2002, now abandoned, which is a continuation of U.S. patent application Ser. No. 09/761,284, filed Jan. 16, 2001, now abandoned.

### STATEMENT REGARDING FEDERALLY SPONSORED RESEARCH OR DEVELOPMENT

(Not Applicable)

### BACKGROUND OF THE INVENTION

1. Field of the Invention

The invention relates to plastic composites including cellulosic fillers, such as wood sawdust. The composites can be used as wood substitutes and in a variety of other applications.

2. Background and Description of the Prior Art

With the changing of global forest resources, reconstituted engineered wood products (wood composites) are being utilized more often as wood substitutes for construction materials, building materials, manufacturing materials, and ‘do-it-yourself’ type projects. However, their application has been, for the most part, restricted to indoor use with low-humidity environment. The exterior utilization of wood composites requires protection against environmental deterioration. One of the major challenges yet today is the manufacture of durable, exterior wood composites that are highly resistant to water and weathering, yet have most of the qualities of real wood.

In the last decade, the manufacture of products from manufactured waste or post-consumer disposed materials has been of growing interest because of economical and environmental benefits. Wood/thermoplastic composite is one of many such materials produced from recycled resources. These composite materials can be relatively light-weight, impervious to corrosion, and have outstanding mechanical properties. They can possess unique flexibility, design capabilities, and provide ease of fabrication, at an affordable price. Such materials are becoming well accepted for an almost endless list of uses as construction materials, and for the fabrication of a wide range of products currently using virgin wood or virgin plastic.

Substantial quantities of low-value plastics waste are generated everyday by household, industry, and commercial users. These plastics are mainly mixed (contaminated) with water, cellulose substances, adhesives, plasticizers, lubricants, metals, sand, ceramics, glass, etc. Though some of these contaminants have beneficial effects on wood-plastic composites, most are detrimental to the process. These waste materials are available at very low cost because, until now, there has been no way to use them. Due to the high cost of drying as well as to a lack of proper technology for cleaning, much of this contaminated plastic waste material is either burned or disposed of in a landfill.

Similarly, there are enormous amounts of cellulosic biomass, or agro-waste. Due to hydrophilic behavior of cellulose, those waste materials generally have high moisture content. In the final processing of these cellulosic materials with various plastics to create actual end products, the cellulosic component is required to be very dry (less than 2% moisture) for it to work as a functional filler for plastics. The drying of the cellulosic in a preliminary discontinuous process has been expensive as is the storage of the dried cellulosic material. In addition, there is a severe fire and explosion hazard in working with the dried cellulosic. The present invention combines the waste plastics with moist cellulosic and in a continuous or discontinuous process, precoats the cellulosic with a polymer while at the same time drying the cellulosic and protecting it from further moisture absorption. In this manner we are able to create a feed stock for wood plastic composite in an inexpensive manner which is highly beneficial not only to the process itself, but to the characteristics of the resulting cellulose/polymer composite product itself.

The ultimate performance of the composite materials depends on various factors, e.g. compatibility between the hydrophilic cellulosic fillers and hydrophobic plastics, the size and quality of the filler, the nature of additives, the processing technology, and so on. Due to the presence of strong intra-molecular hydrogen bonds, cellulosic materials tend to agglomerate, or cling together in bundles rather than being homogeneously dispersed into plastics during processing. As a result, the performance properties of mixed plastic fabrications are highly dependent on the feed stocks used, the preparation of feed stock, and the processing. The many performance negatives of the product are related to the lack of interfacial transfer of energy between incompatible phases or domains. Simply mixed, incompatible plastics and fillers form a week and low performance material.

In the prior art, Gaylord, U.S. Pat. No. 3,645,939 showed good compatibility of plastics, like polyethylene, polyvinyl chloride or acrylic rubber with cellulose by precoating the fibers with a thermoplastic, ethylenecally unsaturated carboxylic acid, or a mixture of acid and a free radical initiator. U.S. Pat. No. 3,943,079 by Hamed, described the pretreatment of cellulose fibers with a plastic polymer and a lubricant. Lochowicz et al. U.S. Pat. No. 4,107,110 described that alfa-cellulose fibers, coated with graft copolymer comprising 1,2-polybutadine to which an acrylate such as butyl methacrylate is grafted could be used in reinforcing of polyethylene and other plastic composites. Goettler, U.S. Pat. No. 4,376,144 showed advantages to combine the bonding agent, like isocyanate, with the cellulose fibers in pre-treatment steps of cellulose-PVC composites. Hawes, U.S. Pat. No. 4,508,860 disclosed an improved fiber pretreatment with vinyl pyridine latex in a water medium. Kokta, U.S. Pat. No. 4,791,020 disclosed the coating of cellulose fiber with an isocyanate bonding agent and polyethylene followed by composites with polyethylene. Raj et al., U.S. Pat. No. 5,120,776 disclosed the pre-treatment of cellulose fiber with maleic anhydride or phthalic anhydride in the presence of an initiator to improve the bonding and dispersability of the filler in polyethylene matrix. Hon, U.S. Pat. No. 5,288,772 disclosed the coating of high moisture newspaper with lignin, then extruded and compression molded into various article. Brooks et al., U.S. Pat. No. 5,759,680 disclosed the encapsulation of cellulose fiber with phenol-aldhehyde and 10-15% low-, and high-density polyethylene, followed by composite extruded profile manufacturing. U.S. Pat. Nos. 5,847,016, and 5,951,927, assigned to Marley Moulding Inc., also described the encapsulating of wood flour, and polyvinyl chloride/chlorinated polyvinyl chloride/polystyrene, stabilizers, lubricants, and processing aids followed by foamed plastic extruded profile.

Paturle, U.K. Pat. No. 1,498,501 described the precoating of cellulose fillers with polyethylene or polypropylene wax or a silicate and the coated particles being embedded in the plastics components. Hishida, U.K. Pat. No. 2,090,503 described the surface coating of jute fibers with various coupling agents, e.g. stearate, silane, titanate, acrylics and so on, and prepared the composites of polypropylene and polystyrene. Kokta, U.K. Pat. No. 2,192,397; 2,192,398; 2,193,503 and 2,203743 showed the coating of cellulose fiber with polyvinyl chloride, polyethylene, polystyrene in presence of isocyanate or silane bonding agent before mixing the cellulose fiber with polystyrene composites. Holbek, PCT Pat. No. 422/81 described the coating of cellulose fibers with a mixtures of polyvinyl chloride, silane coupling agent in an organic solution. Maldas et al. CA Pat. Nos. 2,029,726; 2,029727; 203528; 2037458; 2042574, teaches the method of coating cellulose fibers using one or more mixtures of thermoplastics (e.g. polyvinyl chloride, linear low density polyethylene, medium density polyethylene, high density polyethylene and polystyrene), coupling agent (e.g. lignin, phthalic anhydride or isocyanate), and/or Na-silicate. The composites thus prepared from coated cellulose fibers, inorganic fillers, and polystyrene, possess superior mechanical properties.

### SUMMARY OF THE INVENTION

It is an object of the present invention to make encapsulated filler materials for composites.

It is another object of the present invention to provide an economic method to clean contaminated waste plastic stream.

It is also another object to utilized contaminants present in the scrap plastics as valuable ingredients for encapsulation of cellulose fibers.

It is also an object of the present invention to combine plastic materials in such a way that normally incompatible polymers merge or are compatibilized in the matrix of cellullosic absorbent particles.

It is also another object of the invention to utilize waste plastic and cellulosic materials with high moisture content.

It is an object of this invention to manufacture encapsulated cellulosic filler with hydrophobic characteristics.

It is an object of this invention to dry damp cellulosic materials to less than 2% moisture content and keep them dry.

It is an object of this invention to greatly reduce the possibility of fire or explosive hazard by encapsulating the cellulosic at the same time that it is dried.

It is an object of this invention to use those encapsulated feed stock to make finished and shaped, molded or extruded wood-plastic composites.

It is an object of this invention to make composite materials and articles with improved strength, durability, hydrophobicity, coatability, dimensional stability, and reshapability.

It is yet another object of the present invention to manufacture structural or non-structural members which can substitute for equivalent wood, engineered wood products (wood composites), plastic, and metal products.

It is still another object of the present invention to make light-weight composite articles.

These and other objects of the invention are provided by a process for cleaning contaminated plastic waste by fluxing the plastic and mixing the melted plastic with cellulosic materials, thereby absorbing the plastic and in effect, encapsulating the cellulosic material with the melted plastic. The plastic modified cellulosic material can then be used as a feed stock for making structural and non-structural articles of thermoplastic composite materials. This system advantageously permits the combination of non-compatible materials into various alloys with the cellulosic material. These plastic composites permit the combination of performance properties, e.g., paintability, glueability, stainability, weather resistance, and the like.

Also, this invention relates to a process of encapsulation of cellulosic materials with clean thermoplastic resins, and the use of those encapsulated fillers as a feed stock for making structural and non-structural articles of thermoplastic composite materials.

In the first aspect of the invention, a thermoplastic is mixed with cellulosic material, such as wood sawdust, under conditions in which a specific, predetermined amount of plastic is absorbed into the wood so as to avoid conglomeration of the plastic with the wood. This is accomplished by limiting the quantity of plastic relative to the quantity of cellulosic material, so that there is a sufficient quantity of plastic to coat the wood sawdust but not enough plastic to conglomerate with the wood and any contaminants that may be in the batch.

The plastic can used in a composite or mixture that includes contaminants. The contaminants can be metallic, organic, lubricants, and other types of plastics. By absorbing the primary plastic and avoiding the conglomeration of plastic, the contaminants are either a) absorbed into the cellulosic material, in the case of some liquid contaminants; b) individually coated with the plastic; c) disintegrated to small size fibers or particles and coated with the plastic; or d) segregated from the plastic coated filler in individual particulate. The segregated contaminants can then be screened out, such as through a vibrational mesh system.

The mixing process is performed either in an open air system, or a vented closed system to enable steam and other vapors generated by the heating of the mixture to exhaust. The plastic composite and the cellulosic filler are mixed in a conventional or non-conventional heated and mixing chamber. The mixing process must generates sufficient heat to cause moisture in the cellulosic filler to vaporize and exhaust so that the moisture content of the cellulosic material is reduced, preferably to less than 2 weight %. The vaporization of the moisture in the cellulosic material also serves to expand the cellulosic material, improving absorption of the plastic. The plastic is melted by the heat and is thus absorbed or blotted by the cellulosic material. The absorbed plastic thus coats the cellulosic material. This coating prevents moisture from reentering the cellulosic material. The energy consumed to coat cellulosic materials with plastics will be partially recovered as the coating provides lubrication and thus reduced energy costs for further processing.

In a second aspect of the invention, the thus encapsulated cellulosic material can be combined with other thermoplastics to achieve a desired combination of properties for the end material. In fact, by using the encapsulated cellulosic material as a base, otherwise incompatible thermoplastics can be combined. For example, remixing in a second stage, either continuous or discontinuous, plastics with different melt temperatures can be combined. Coupling/bonding agents and a further coating of yet another plastic may also be utilized. The binder could even be a cold plastic such as polyester.

In a continuous or discontinuous process, the invention can include the steps of introducing a first thermoplastic and a cellulosic material into a mixer in sufficient ratio of cellulosic material to said first thermoplastic that, when melted, said first thermoplastic is at least partially absorbed into or blotted onto, said cellulosic material so that it does not conglomerate with the said cellulosic material. At this point, in either a continuous or discontinuous process, the first thermoplastic/cellulistic can be cooled and a second thermoplastic or thermoplastic/cellulistic can be melted and combined or coated over the first such thermoplastic-cellulosic material.

The ratio is preferably at least 1.0 representing at least 50 weight % cellulosic and no more than 50 weight % of the first thermoplastic. Increased ratios for 1.5 and 2.0 are also possible.

A significant aspect of the process is that it enables the use of contaminated plastics. By limiting the quantity of plastic relative to the cellulosic material, the thermoplastic is absorbed and coats the cellulosic material, while separating out solid components of the contaminants. In the process, the solid contaminants can, for example, have a higher melt temperatures than said thermoplastic, and the melting step is limited to a temperature to melt said first thermoplastic but not melt the contaminants; ie, the higher temperature melt plastics or solids. After cooling, said solids can be disconnected from the cellulosic material, but may mix homogeneously as integrated particles and fibers.

The bigger and unchanged solids are filtered from the composition. For example, the solids can be filtered out by vibrational mesh.

Once the thermoplastic coated cellulosic material is generated, it can be mixed, either continuously or discontinuously, with a further additive or additives. Such further additive can be more of the first thermoplastic to increase the quantity of the first thermoplastic for a particular application. Likewise, the additive can also be a second thermoplastic to achieve a combination of properties provided by different thermoplastics along with coupling agents and other additives.

The process of the invention can be used in parallel for two different thermoplastics to be later combined. Thus, the process can further include the steps, either continuously or discontinuously, of introducing a second thermoplastic and a second cellulosic material into a heated mixer in sufficient ratio of cellulosic material to second thermoplastic that, when melted, said second thermoplastic is at least partially absorbed into said cellulosic material and does not conglomerate outside said cellulosic material; melting said second thermoplastic; and cooling said second thermoplastic-second cellulosic material composition. Again, either continuously or discontinuously, the cooled second thermoplastic-second cellulosic material composition can be mixed with the cooled first thermoplastic-cellulosic material composition.

The first thermoplastic and said second thermoplastic can be compatible. Alternatively, the first and second can be incompatible and a binder can be added.

These processes may use either a low pressure or high pressure mixer. Preferably, the mixer provides a vent for releasing vapors during mixing.

The thermoplastics used can be any of a number of types, including polyethylene, polypropylene, polystyrene, polyvinyl chloride or ethylene vinyl acetate.

According to another aspect of the invention, a composition made by the process is unique and provides advantages including reduced costs compared to encapsulated filler made from “clean” thermoplastics. The composition has at least 50 parts per hundred of a cellulosic material formed in particulates; and no more than 50 parts per hundred of a thermoplastic absorbed into said particulates of cellulosic material and substantially coating said particulates of cellulosic material, whereby the quantity of thermoplastic is sufficient to absorb into the particulates but insufficient to conglomerate outside said particulates. The composition, prior to filtering may have at least 1 part per hundred of contaminants formed in contaminant particulates separate from said cellulosic material particulates.

The cellulosic particulates can include, for example, sawdust or wood flour. The average mesh size of the cellulose fillers varies from 5 mesh to 100 mesh. The average fiber aspect ratio (average length to average diameter of the fibers) also varies from 1 to 300.

According to another aspect of the invention, the process can be performed in an iterative fashion, using sample batches of a particular plastic to determine proper mixing conditions to encapsulate the filler with the plastic, while avoiding conglomeration. For example, the process can include the steps of: (a) selecting said at least one recycled plastic, wherein said at least one recycled plastic has a meltable plastic portion of at least 70%; (b) selecting said at least one cellulosic filler; (c) adding a first amount of said at least one recycled plastic to a blending chamber; (d) adding a first amount of said at least one cellulosic filler to said blending chamber to form first combined materials, wherein said at least one cellulosic filler comprises about 50 to 80 weight % of said first combined materials; (e) thereafter heating said first materials in the blending temperature at a range from about 250 F to 600 F, whereby said at least one cellulosic filler is encapsulated to form said plastic encapsulated cellulosic filler; alternatively, (f) adding only a first amount of said at least one recycled plastic, or only adding a first amount of said at least one cellulosic filler to said blending chamber and heating said recycled plastic or said cellulosic filler alone for a first blending temperature, wherein said first blending temperature is in a range from about 250 F to 600 F; and then adding a first amount of said at least one cellulosic filler or a first amount of said at least one recycled plastic to said blending chamber; thereafter, heating said material remaining in said blending chamber for a second blending temperature, whereby said at least one cellulosic filler is encapsulated to form said plastic encapsulated cellulosic filler; and (g) comparing a sample of said plastic encapsulated cellulosic filler to a reference.

From this comparison, the process further involves: (h) determining a set of production settings comprising an amount of said at least one recycled plastic, blending temperature(s), an amount of said at least one cellulosic filler and blending temperature(s) suitable for batch processing; and (i) processing a plurality of batch processes to form said plastic encapsulated cellulosic filler under said set of production settings, if said determination can be made from said comparing.

The process can further include the steps of: determining a set of experimental settings comprising an amount of said at least one recycled plastic, said determined blending temperature(s), said determined amount of said at least one cellulosic filler and said determined blending temperature(s) if said determination in step (h) is not possible; repeating (a) through (g) using said experimental settings until said production settings are determined; and processing a plurality of batch processes to form said plastic encapsulated cellulosic filler under said set of production settings, once said production settings are determined. The process can also include shredding, and/or densifying/pelletizing said at least one recycled plastic. It is intuitively obvious that the invention can be applied to virgin plastics as well as recycled plastics except there would be no need for the “cleaning” aspect of the invention

In the processes according to the invention, recycled plastics from a variety of sources can be used. For example, the plastic can be obtained from plastic waste selected from, but not limited to, grocery bags, agricultural films, plastic sheets, disposable cups, plates, containers, industrial scrap and municipal waste. The recycled plastics can include homopolymers or copolymers selected from the group consisting of ethylene, polypropylene, vinyl chloride, styrene, acrylonitride, butadiene, acrylic acid, methacrylic acid, methylacrylate, methylmethacrylate, acrylamide, carbonates, polybutylene terephthalate, polyethylene naphthalate, cellulose acetate, cellulose acetate butyrate, polyacetal, poly(vinyl butyral), polyurethane, and mixtures thereof.

Significantly, a non-meltable portion of the waste may comprise carbon particles, scrap tire regrind, high melting thermoplastics, recycled thermosetting plastic regrind, reclaimed fibers from carpet waste, e.g. polyester or nylon fibers, and inorganic materials, e.g. mica, talc, calcium carbonate, silica, glass fibers, asbestos or wollastone. The recycled plastic may further comprise at least one contaminant consisting of adhesives, paints, lubricants, and plasticizers. The recycled plastic may also further comprise at least one non-hazardous contaminate consisting of metals, glass, ceramics and sands.

The recycled plastic can have initial moisture content from about 0.5 percent to about 50 percent. The method can include drying the plastics in a dryer to reduce moisture content all the way down to 0.5 percent or less.

According to the invention, the cellulosic filler is preferably selected from woods consisting of softwood pulp, hardwood pulp, sawdust, wood flour, waste wood and mixtures thereof. The cellulosic filler can also be selected from non-wood plants consisting of rice hull, grass straw, cereal straw, bagasse, nutshells, corn cobs, jute and mixtures thereof. The cellulosic filler typically has a moisture content of between about 5 percent to 50 percent. The method can include drying the cellulosic filler in a dryer to reduce moisture content all the way down to 2 percent or less.

The process preferably uses a blending chamber in a high- or low-intensity mixer. Preferably, the blending chamber is selected from the group consisting of a high-speed turbine mixer, paddle-type compounder/plastic processor, single screw or twin screw compounder or extruder, as well as a roll mill.

According to another aspect of the invention, a method of making a wood substitute article includes the steps of: (a) compounding continuously or discontinuously at least one encapsulated cellulosic filler with at least one thermoplastic and at least one bonding agent and at least one additive under elevated temperature, whereby a homogeneous molten mass is generated; (b) forming said molten mass to form said wood substitute article; (c) cooling said wood substitute article, and optionally (d) trimming and/or cutting said wood substitute article. In this process, the thermoplastic is preferably a recycled thermoplastic or a virgin thermoplastic.

The thermoplastic can be a homopolymer and/or copolymer selected from the group consisting of ethylene, polypropylene, vinyl chloride, styrene, acrylonitride, butadiene, acrylic acid, methacrylic acid, methylacrylate, methylmethacrylate, acrylamide, carbonates, polyethylene terephthalate, urethane, cellulose acetate, cellulose acetate butyrate, polyacetal, poly(vinyl butyral), and mixtures thereof.

The bonding agent is preferably selected from the group consisting of maleated thermoplastics, unsaturated acid, anhydride, peroxides, polyol, polyether polyol, isocyanate, and their mixtures thereof. The additive is preferably selected from the group consisting of a stabilizer, lubricant, impact modifier, colorant and inorganic filler.

The stabilizer is preferably selected from the group consisting of barium, cadmium, zinc, calcium, cobalt salts of stearic acid, phosphorous acid esters, epoxy compounds, phenol derivatives and their mixtures thereof. The lubricant is preferably selected from the group consisting of mineral oil, calcium stearate, stearic acid, polyethylene wax, maleated wax, acrylic copolymer, and their mixtures thereof.

The impact modifier is preferably selected from the group consisting of acrylonitrile-butadiene-styrene (ABS), acrylic copolymer, chlorinated polyethylene (CPE), ethylene vinyl acetate (EVA), and their mixtures thereof.

The inorganic filler is preferably selected from the group consisting of mica, talc, calcium carbonate, silica, glass fibers, asbestos and wollastone.

A foaming agent and a blowing agent can also be added in the process. The foaming agent can be selected from the reaction products of a first group selected from an unsaturated polyol and a saturated polyol and a second group selected from a polyisocyante and diisocyante. The blowing agent is preferably selected from the group consisting of water, carbon dioxide, nitrogen, trichloromon-fluoromethane, dibrom difluoromethane, dichlorodifluoro-methane and halogeninated paraffins.

Micro beads and/or pressurized air or gas can also be added. The micro beads can be selected from the group consisting of glass, polyethylene, polypropylene, polystyrene and polyvinyl chloride.

The compounding step can be performed in a plastic processor, which can be either a single-screw extruder, a twin-screw extruder, a paddle mixer, a high intensity mixer or an injection molding machine.

Although the prior art showed precoating/encapsulation of cellulosic materials with certain types of plastics, the particular features of the present invention are absent from the prior art. The prior art has attempted to achieve compatibility between cellulosic materials and thermoplastic by using a specific binder/stabilizers/lubricant/processing aids.

Thus, the invention provides a cleaning process to bring meltable scrap plastics to the selected temperature for melting whereby the designated plastics melt and are assimilated or absorbed into cellulosic materials without congealing the cellulosics that are used with the contaminants. These contaminants include high melting thermoplastic resins, thermosetting resins, metals, glass and various other refuses. As long as there is a sufficient cellulosic proportion to absorb the melted or fluxed material, the contaminants are either a) absorbed into the cellulosic material, in the case of some liquid contaminants; b) individually coated with the plastic; c) disintegrated to small size fibers or particles and coated with the plastic; or d) segregated from the plastic coated filler and can easily be screened off, leaving clean, encapsulated cellulosic material as a base material for additional processing.

According to the present invention, the dispersion of discontinuous fillers into a polymeric matrix can improve by the fillers blotting or absorbing the plastics, thus encapsulating the fillers in the process with a microscopically thin layer of plastic. The compatibility between discontinuous filler phase and continuous plastic phase can be enhanced by further addition of one or more coupling agents during the composite processing of the thermoplastic(s).

The present invention, however, discloses a method where cellulosic and/or non-cellulosic materials being encapsulated with waste thermoplastics without binder, stabilizers, lubricant, processing aids, and at the same time, enables the cleaning of waste plastics with non-hazardous contaminants. The compatibility can be improved by encapsulating the fillers with uncleaned plastic with valuable contaminants which may act as a compatibilizer/dispersing agent to establish compatibility between filler and plastic. The non-meltable portion of the recycled plastic may include inorganic materials which, in many cases, have the additional benefit to act as a fluxing agent that lowers the melting or softening temperature of the plastic.

At the same time, during blending of the cellulosic materials under high energy and at a temperature higher than the boiling temperature of water, and in presence of moisture, nonmeltable plastics and other hydrophobic materials present in the plastic scrap will either be softened or be integrated and will assist to develop hydrophobic character, and compatibilize the cellulosic materials with the normally incompatible thermoplastics.

### BRIEF DESCRIPTION OF THE DIAGRAMS

A more thorough understanding of the invention can be gained by a reading of the following detailed description together with a review of the accompanying drawings, in which:

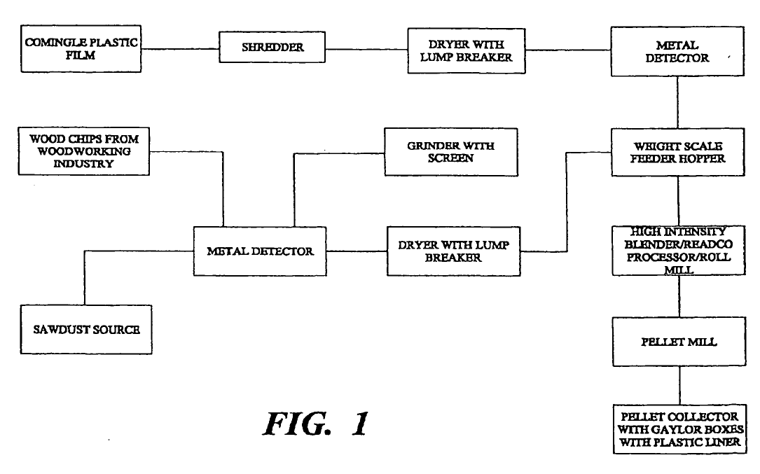

FIG. 1 is a flow diagram illustrating a process for making plastic modified cellulosic material;

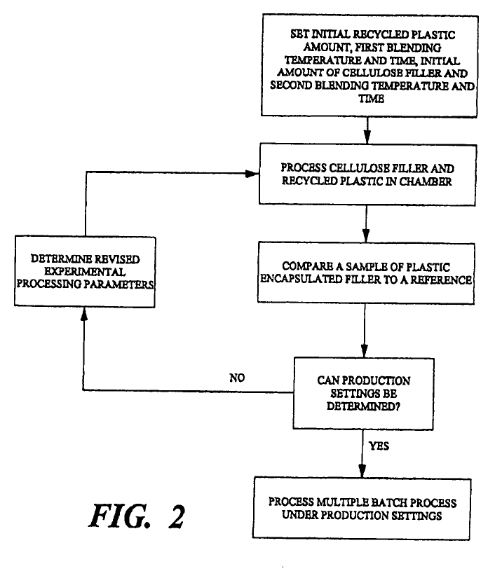

FIG. 2 is a flow diagram illustrating an iterative method for making plastic modified cellulosic filler; and

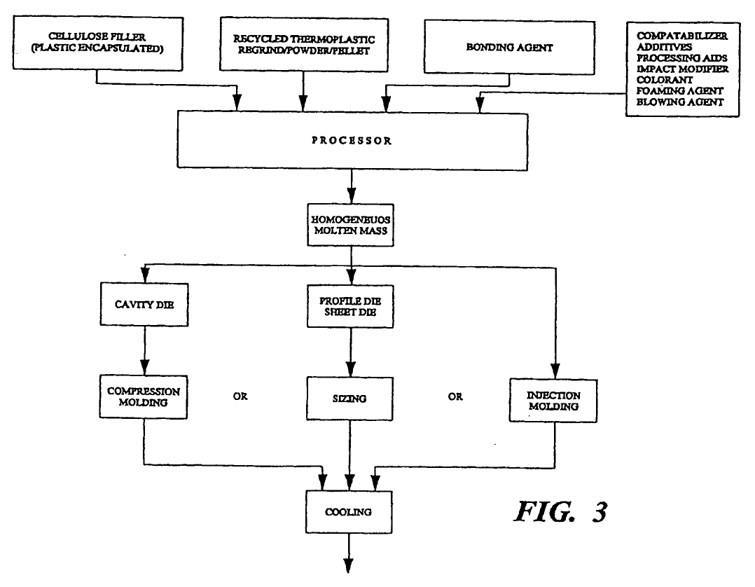

FIG. 3 is a flow diagram showing a sequential method of making a wood substitute article.

### DETAILED DESCRIPTION OF PREFERRED EMBODIMENTS

The invention relates to a process for cleaning contaminated plastic waste by absorbing the fluxed plastics with the use of specific amounts of cellulosic materials so that the cellulosics become encapsulated with the fluxed plastic without, at the same time, being conglomerated with such fluxed plastics. The resulting individually coated cellulosic materials are then screened off from the remaining non-fluxed plastics and other non-meltable contaminants. The plastic modified cellulosic materials can be used as a feed stock for making structural and non-structural articles of thermoplastic composite materials with the added advantages of being able to combine non-compatible plastics into various alloys with the cellulosic materials. These plastic alloys permit the engineering of formulas to specific property requirements, i.e. good strength, environmental stability, paintability, glueability, stainability, etc.

Referring to FIG. 1, a recycled thermoplastic is first selected. The recycled thermoplastics used in this invention can be recovered from plastic coated/laminated paper waste, grocery bags, agricultural-used films, any type of plastic sheet, disposable cups, plates, containers, or any other form of scrap materials from ordinary industrial or municipal waste. More precisely, those plastics are recovered from household recycling programs, from plastic recycling centers, and from various sectors of industry, e.g. recycled paper-mills, fast-food restaurants, the packaging industry, the window and door industry, the furniture industry, house renovation companies, the automotive industry, and others. Recycled plastics are homopolymer and/or copolymers of ethylene, polypropylene, vinyl chloride, styrene, acrylonitride, butadiene, acrylic acid, methacrylic acid, methylacrylate, methylmethacrylate, acrylamide, carbonates; polybutylene terephthalate, polyethylene naphthalate, cellulose acetate, cellulose acetate butyrate; polyacetal, poly(vinyl butyral), polyurethane, and mixtures thereof. Those plastics may optionally be shredded, densified, granulated or regrind, before being added to the mixer. The plastics may contain <1 weight percent to 50 weight percent moisture. If desired, the moisture content of the plastics may be reduced to 0.5 weight % or even less by an additional drying step. In case of bulky plastic scrap, e.g. foam or thin films, the plastic waste may be shredded followed by densifying or pellelitizing in a conventional method, prior to addition to the blender.

An initial amount of recycled plastic and/or an initial amount of cellulosic filler is added to a blending chamber at the same time or one after another where the recycled plastic and cellulosic filler is heated. In the preferred embodiment of this invention, the blending chamber is a high- or low-intensive mixer. Preferably, the blending chamber is selected from the group consisting of a high-speed turbine mixer, paddle-type compounder/plastic processor, single screw or twin screw compounder or extruder, as well as a roll mill.

The term cellulose filler includes fillers derived from soft wood, hard wood pulps, a mixture of hardwood and softwood pulp or sawdust or wood flour from wood working/furniture industry or waste wood. The cellulosic fillers can also be selected from particles of non-wood plants, e.g. rice hull, grass straw, cereal straw, bagasse, nutshells, corn cobs, jute and the like. The cellulosic materials used of the invention may be any material made from cellulose, e.g. newsprints, textiles, paperboard, and any other materials having cellulosic fibers. The average mesh size of cellulose fillers can vary from 5 mesh to 100 mesh. The average fiber aspect ratio (average length to average diameter of the fibers) of can also vary from 1 to 300. Mixtures of fibers having different mesh sizes and average aspect ratios are preferably employed.

The non-meltable portions of the recycled plastic can include carbon particles, scrap tire regrind, high melting recycled plastics, recycled thermosetting plastic regrind, reclaimed fibers from carpet waste, e.g. polyester or nylon fibers. The inorganics can be selected from mica, talc, calcium carbonate, silica, glass fibers, asbestos or wollastone. The initial moisture content of the filler can be from about 5 percent to about 50 percent. If necessary, fillers can be dried in a dryer to dry at a moisture content of from about 0.5 percent to about 2 percent.

The temperature, pressure and blending time in the blending chamber should be sufficiently high to melt at least 70% of the plastic materials and produce a homogeneous mixture with the filler. The blending temperature can be from about 250 F to about 600 F. Excessive heat should be avoided so as to not burn the cellulosic filler. The fusible portions of the plastics will develop a thin microscopic layer on the cellulosic filler surface. Under high pressure and temperature in the mixer, the non-fusible part of the recycled plastic will disintegrate in to fibers/particles, and can also act as fillers.

Contaminants such as adhesives, lubricants, plasticizers and inorganic fillers may be present in the waste plastics. Such materials can act as promoters to encapsulate the hydrophilic cellulosic filler with hydrophobic plastic. Other solid contaminants (if any), like metals, ceramics, glass pieces, can be separated from the recycled plastic.

The optimum blending temperature(s) and time of heating the cellulosic fiber or the recycled plastic alone and together will depend upon number of factors, such as the type of mixer, the proportions of the plastics and filler, moisture content of the plastic and filler, melting temperature of the plastics, and the size and temperature of the batch. The proportions of the ingredients will usually dictate the properties of the encapsulated filler. Generally, the ratio of filler to plastic will be as high as possible in order to maximize production of the modified filler. The amount of polymer used will be at least sufficient to prevent fiber-to-fiber interactions of cellulosics, usually at least 30 parts of meltable plastic by weight per 100 parts by weight of fillers (dry).

After encapsulation, the coated fillers may be subsequently passed through continuous processing chamber or in a discontinuous manner through a lump breaker, and an automatic screener. The screener can separate the contaminates which will not pass through a screen size from 5 mesh to 10 mesh. Metal particles passing through the automatic screener may be separated by a metal detector.

Preferably, a sample of the plastic encapsulated cellulosic filler is then evaluated by comparison to a reference. The comparison may be performed manually or by a computer. If the initial processing conditions allow determination of production processing conditions, a plurality of batch process to form plastic encapsulated filler will be performed. If production processing conditions cannot be determined based on comparison to the reference, additional experiments using revised processing conditions will be used to identify production processing conditions.

Referring to FIG. 2, if production processing parameters are not met when comparing the sample to a reference, a revised set of processing parameters are applied iteratively until a set of production processing parameters are determined. Once determined, a plurality of batch process to form plastic encapsulated filler will be performed.

The plastic encapsulated cellulosic filler may be sold as such, or used in a continuous process as an intermediate to form other products. In particular, plastic encapsulated cellulosic filler may be combined with thermoplastics to form wood substitute articles.

Referring to FIG. 3, structural and non-structural wood substitute articles are manufactured by compounding a single type of plastic encapsulated cellulosic filler, or a mixture of different types of plastic encapsulated fillers, and a thermoplastic resin, bonding agents, and additives. Optionally, a foaming agent combined with a blowing agent or micro beads or pressurized air/gas may be added to lighten the composition.

Thermoplastics are homopolymer and/or copolymers of ethylene, polypropylene, vinyl chloride, styrene, acrylonitride, butadiene, acrylic acid, methacrylic acid, methylacrylate, methylmethacrylate, acrylamide, carbonates; polyethylene terephthalate; cellulose acetate, cellulose acetate butyrate; polyacetal, poly(vinyl butyral); and mixtures thereof. The preferred thermoplastic resins are any grades of low-density-, linear low-density-, medium density-, high-density-polyethylene (PE); polypropylene (PP); polyvinyl chloride (PVC); polystyrene (PS); acrylonitrile-butadiene-styrene (ABS); polycarbonates; ethylene vinyl acetate copolymer (EVA); polyethylene terephthalate (PET); polyurethane; cellulose acetate and cellulose acetate butyrate; polyacetal, poly(vinyl butyral), and their mixtures thereof. The thermoplastics may be rigid, flexible recycled resin or virgin resin, or in the form of regrind, pulverized powder, beads, pellet, densified, and flakes.

The additives can include stabilizers, lubricants/processing aid, impact modifiers, crossing agents/bonding agents/coupling agents, or colorants. The stabilizers can be any of the commercial or proprietary type, e.g. barium, cadmium, zinc, calcium and cobalt salts of stearic acid; phosphorous acid esters; epoxy compounds, phenol derivatives, and their mixtures thereof.

The lubricants/processing aid can also be any of the commercial or proprietary type, e.g. mineral oil, calcium stearate, stearic acid, polyethylene/paraffin wax, maleated wax, acrylic copolymer, and their mixtures thereof. The impact modifiers can include any of the commercial or proprietary type, e.g. acrylonitrile-butadiene-styrene (ABS), acrylic copolymer, chlorinated polyethylene (CPE), ethylene vinyl acetate (EVA), and their mixtures thereof.

The bonding agents can be any of the commercial or proprietary type, e.g. mixtures of an unsaturated acid, and an activator; polyol or polyether polyol; and an isocyanate, preferably polymeric diphenylmethane diisocyanate (MDI), and their mixtures thereof. Maleated plastics, maleic anhydride or phthalic anhydride is the preferred bonding agent. Suitable activators are dicumyl peroxide, benzoyl peroxide and di-t-butyl peroxide. The bonding agent of the invention includes those agents which have been found to be effective in enhancing adhesion with cellulosic materials, for example, an ethylenically unsaturated carboxylic acid, substituted carboxylic acid or carboxylic acid anhydride.

For example, the bonding process can be explained as follows: maleic anhydride, for example, reacts with OH groups of cellulose in the presence of an activator and a polymer, which acts as a binder, to form a cellulose maleate half ester. The half ester subsequently reacts with the polymer in the presence of a free radical initiator such as dicumyl peroxide, the unreacted peroxide in the pre-treated fiber acts as a means for generating free radicals on the polymer, thus the plastic and cellulose are linked together by means of maleic anhydride forming a bridge between the normally uncompatible cellulose and thermoplastic. Moreover, in the presence of polyol (e.g. polyethylene/polypropylene, or polyether polyol) and isocyanate, polyester and polyurethane type of reaction will occur. The complex and cross-linked chemical reaction will provide good interfacial bond between filler and matrix phases, resulting strong and durable composite products. At the same time, the foam structure, which should be provided during the cross-linking reaction, provides a light-weight composite product.

To manufacture a further reduced density, wood substitute article, a foaming agent combined with a blowing agent may be added. Pressurized air/gas, or air-encapsulated micro beads may also be used to reduce the product density. The micro beads are any of the commercial or proprietary type, e.g. glass, polyethylene, polypropylene, polystyrene, polyvinyl chloride.

Various alternate forming methods are available to form the wood substitute article. A single-screw, twin-screw, plastic processor, injection molding machine under elevated temperature and pressure; followed by compressing the molten mass in a flat or cavity mold under elevated pressure; or passing the molten mass through a profile die or sheet die to make the desired shape of the structural/non-structural article; sizing the said molten profile/sheet by passing through a double belt press or pair of rollers of the calendar unit, cooling the said article by immersion/sprinkle in cold water streaming, trimming and cutting the said cooled article to a particular size and length. The preferred method is to add plastics, and different ingredients into the extruders/compounders to its different ports. Components may be added simultaneously or in different orders to the blending chamber. The preferred blending temperature is specific to the thermoplastic used, approximately the softening temperature of the thermoplastic or about 50 degrees higher. Using the above-described process, plastic encapsulated cellulosic fillers can be processed into structural and non-structural composite wood substitute articles.

The following is a typical example of the range of ingredients to formulate a finished molded wood substitute article:

Ingredients are Described in Weight Parts Per Hundred

Plastic: 30-50

Cellulosic filler: 50-70

Non-cellulosic fillers: 1-20

Binding agents: 0.02-5

Stabilizers: 0-3

Lubricants: 0-2

Impact modifiers: 0-10

Colorant: 0.1-10

Foaming agent: 0.5-5

Blowing agent: 0.005-0.5

Further examples include 50-50 densified PE and sawdust; 50:50, densified hydro pulp and sawdust; 50:50 non-foam PS stray regrind and sawdust; 40:50, PP film regrind and sawdust; 50:50, PP film regrind and sawdust; 10:40:50, EVA, densified PE and sawdust; and 10:40:50 EVA, PS regrind and sawdust.

While several embodiments of the invention are illustrated, it will be understood that the invention is not limited to these embodiments. Those skilled in the art to which the invention pertains may make modifications and other embodiments employing the principles of this invention, particularly upon considering the foregoing teachings.

What is claimed is:

1. A method for forming a plastic encapsulated cellulosic filler by melt blending at least one cellulosic filler with at least one recycled plastic, comprising:
(a) selecting said at least one recycled plastic, wherein said at least one recycled plastic has a meltable plastic portion of at least 50%;
(b) selecting said at least one cellulosic filler;
(c) adding a first amount of said at least one recycled plastic to a blending chamber;
(d) adding a first amount of said at least one cellulosic filler to said blending chamber to form combined first materials of said first amount of said at least one recycled plastic and said first amount of said at least one cellulosic filler, wherein said at least one cellulosic filler comprises at least 66.67 to 80 weight % of the combined first materials;
(e) thereafter heating said first materials in the blending chamber at a temperature at a range from about 250 F to 600 F, whereby said at least one cellulosic filler is encapsulated to form said plastic encapsulated cellulosic filler.

2. The method of claim 1, further comprising the steps of:
(f) comparing a sample of said plastic encapsulated cellulosic filler to a reference;
(g) determining a set of production settings comprising an amount of said at least one recycled plastic, an amount of said at least one cellulosic filler and blending temperature(s) suitable for batch processing; and
(h) processing a plurality of batch processes to form said plastic encapsulated cellulosic filler under said set of production settings, without conglomeration of the plastic outside the cellulosic filler.

3. The method according to claim 1, further comprising:
determining a set of experimental settings comprising an amount of said at least one recycled plastic, said determined amount of said at least one cellulosic filler and said determined blending temperature(s);
repeating (a) through (g) using said experimental settings and adjusting the experimental settings until said production settings are determined that form encapsulated cellulosic filler without conglomeration of the plastic outside the cellulosic filler;
processing a plurality of batch processes to form said plastic encapsulated cellulosic filler under said set of production settings, once said production settings are determined.

4. The method according to claim 1, wherein the said at least one recycled plastic are recovered from plastic waste selected from the group consisting of grocery bags, agricultural films, plastic sheets, disposable cups, plates, containers, industrial scrap and municipal waste.

5. The method according to claim 1, wherein the said at least one recycled plastics are homopolymers or copolymers selected from the group consisting of ethylene, polypropylene, vinyl chloride, styrene, acrylonitride, butadiene, acrylic acid, methacrylic acid, methylacrylate, methylmethacrylate, acrylamide, carbonates, polybutylene terephthalate, polyethylene naphthalate, cellulose acetate, cellulose acetate butyrate, polyacetal, poly(vinyl butyral), polyurethane, and mixtures thereof.

6. The method according to claim 1, wherein said at least one recycled plastic has an initial moisture content from about <1 percent to about 50 percent.

7. The method according to claim 1, wherein said at least one recycled plastic is dried in a dryer to reduce moisture content to 2 percent or less.

8. The method according to claim 1 wherein said at least one recycled plastic further comprises at least one contaminant from a group which is comprised of at least one adhesive, lubricant, paint, or plasticizer.

9. The method according to claim 1, wherein said at least one recycled plastic further comprises at least one non-hazardous contaminant from the group consisting of metals, glass, ceramics and sands.

10. The method according to claim 1, wherein said at least one cellulosic filler is selected from woods consisting of softwood pulp, hardwood pulp, sawdust, wood flour, waste wood and mixtures thereof.

11. The method according to claim 1, wherein said at least one cellulosic filler is selected from non-wood plants consisting of rice hull, grass straw, cereal straw, bagasse, nutshells, corn cobs, jute and mixtures thereof.

12. The method according to claim 1, wherein said blending chamber is high-speed turbine mixer.

13. The method according to claim 1, wherein said blending chamber is selected from the group consisting of a paddle-type compounder/plastic processor, single screw or twin screw compounder or extruder, and a roll mill.

14. The method according to claim 1, wherein the said at least one cellulosic filler has a moisture content of between about 5 percent to 50 percent, and is dried in a dryer to reduce moisture content to about 0.5 percent to about 2 percent.

15. The method according to claim 1, wherein the said plastic encapsulated cellulosic filler are dry with moisture content less than 1 percent.

16. The method according to claim 1, wherein the at least one cellulosic filler comprises about 100 parts and the plastic comprises about 30 parts of the combined first materials.

17. A method for forming a plastic encapsulated cellulosic filler by melt blending at least one cellulosic filler with at least one recycled plastic, comprising:
(a) selecting said at least one recycled plastic, wherein said at least one recycled plastic has a meltable plastic portion of at least 50%;
(b) selecting said at least one cellulosic filler;
(c) adding a first amount of said at least one recycled plastic and heating said recycled plastic for a first blending temperature, wherein said first blending temperature is in a range from about 250 F to 600 F; and
(d) adding a first amount of said at least one cellulosic filler to form a first combined material, wherein said at least one cellulosic filler comprises at least 66.67 to 80 weight % of the combined first materials; thereafter, heating said first combined material remaining in said blending chamber for a second blending temperature, whereby said at least one cellulosic filler is encapsulated to form said plastic encapsulated cellulosic filler without said plastic conglomerating outside said cellulosic filler.

18. A method for forming a plastic encapsulated cellulosic filler by melt blending at least one cellulosic filler with at least one recycled plastic, comprising:
(a) selecting said at least one recycled plastic, wherein said at least one recycled plastic has a meltable plastic portion of at least 50%;
(b) selecting said at least one cellulosic filler;
(c) adding a first amount of said at least one cellulosic filler and heating said cellulosic filler for a first blending temperature, wherein said first blending temperature is in a range from about 250 F to 600 F; and
(d) adding a first amount of said at least one recycled plastic to form a first combined material, wherein said at least one cellulosic filler comprises at least 66.67 to 80 weight % of the combined first materials; thereafter, heating said first combined material remaining in said blending chamber for a second blending temperature, whereby said at least one cellulosic filler is encapsulated to form said plastic encapsulated cellulosic filler without said plastic conglomerating outside said cellulosic filler.

19. A method of making a thermoplastic-cellulosic material composition, said method comprising the steps of:
introducing a first thermoplastic and a cellulosic material into a mixer in sufficient ratio of cellulosic material to said first thermoplastic that, when melted, said first thermoplastic is at least partially absorbed into said cellulosic material and does not conglomerate outside said cellulosic material, wherein said cellulose to plastic ratio is at least 2.00;
melting said first thermoplastic; and
cooling said first thermoplastic-cellulosic material composition.
